(19) United States
(12) Patent Application Publication
(10) Pub. No.: US 2023/0197084 A1
(43) Pub. Date: Jun. 22, 2023

(54) APPARATUS AND METHOD FOR CLASSIFYING SPEAKERS BY USING ACOUSTIC SENSOR

(71) Applicant: SAMSUNG ELECTRONICS CO., LTD., Suwon-si (KR)

(72) Inventors: Jaehyung JANG, Anyang-si (KR); Cheheung Kim, Yongin-si (KR); Daehyuk Son, Suwon-si (KR)

(73) Assignee: SAMSUNG ELECTRONICS CO., LTD., Suwon-si (KR)

(21) Appl. No.: 17/832,064

(22) Filed: Jun. 3, 2022

(30) Foreign Application Priority Data
Dec. 20, 2021 (KR) 10-2021-0183129

(51) Int. Cl. G10L 17/06; G10L 17/04; H04R 1/40; H04R 3/00; G10L 17/22

(52) U.S. Cl. CPC G10L 17/06; G10L 17/04; H04R 1/406; H04R 3/005; G10L 17/22; G06Q 10/10

(57) ABSTRACT

Provided is a speaker classifying apparatus including an acoustic sensor, and a processor configured to obtain a first direction of a sound source within an error range of −5 degrees to +5 degrees based on a first output signal output from the acoustic sensor, recognize a speech of a first speaker in the first direction, obtain a second direction of the sound source within the error range of −5 degrees to +5 degrees based on a second output signal output after the first output signal, and recognize a speech of a second speaker in the second direction based on the second direction being different from the first direction.

### CROSS-REFERENCE TO RELATED APPLICATION

This application claims priority to Korean Patent Application No. 10-2021-0183129, filed on Dec. 20, 2021, in the Korean Intellectual Property Office, the disclosure of which is incorporated by reference herein in its entirety.

### BACKGROUND

### 1. Field

Example embodiments of the present disclosure relate to apparatuses and methods for classifying speakers by using an acoustic sensor.

### 2. Description of Related Art

Acoustic sensors, which are mounted in household appliances, image display devices, virtual reality devices, augmented reality devices, artificial intelligence speakers, and the like to detect a direction from which sounds are coming and recognize voices, are used in increasingly more areas. Recently, a directional acoustic sensor that detects sound by converting a mechanical movement due to a pressure difference, into an electrical signal has been developed.

### SUMMARY

One or more example embodiments provide apparatuses and methods for classifying speakers by using an acoustic sensor.

Additional aspects will be set forth in part in the description which follows and, in part, will be apparent from the description, or may be learned by practice of example embodiments of the disclosure.

According to an aspect of an example embodiment, there is provided a speaker classifying apparatus including an acoustic sensor, and a processor configured to obtain a first direction of a sound source within an error range of −5 degrees to +5 degrees based on a first output signal output from the acoustic sensor, recognize a speech of a first speaker in the first direction, obtain a second direction of the sound source within the error range of −5 degrees to +5 degrees based on a second output signal output after the first output signal, and recognize a speech of a second speaker in the second direction based on the second direction being different from the first direction.

The processor may be further configured to recognize a change of a speaker based on the first direction or the second direction being maintained or changed with respect to continuous output signals.

The processor may be further configured to register the first speaker and a recognized voice of the first speaker based on the speech of the first speaker being recognized.

The processor may be further configured to compare a similarity between a voice corresponding to the second output signal with a registered voice of the first speaker.

The processor may be further configured to recognize a speech of a second speaker in the second direction based on the second direction being different from the first direction and the similarity being less than a first threshold.

The processor may be further configured to recognize the speech of the first speaker based on the similarity being greater than a second threshold value.

The processor may be further configured to recognize voices respectively corresponding to the speech of the first speaker and the speech of the second speaker, and classify the recognized voices based on speakers.

The acoustic sensor may include at least one directional acoustic sensor.

The acoustic sensor may include a non-directional acoustic sensor and a plurality of directional acoustic sensors.

The non-directional acoustic sensor may be provided at a center of the speaker classifying apparatus, and wherein the plurality of directional acoustic sensors may be provided adjacent to the non-directional acoustic sensor.

The first direction and the second direction may be estimated different from each other based on a number and arrangement of the plurality of directional sensors.

A directional shape of output signals of the plurality of directional acoustic sensors may include a figure-of −8 shape regardless of a frequency of a sound source.

According to another aspect of an example embodiment, there is provided a minutes taking apparatus using an acoustic sensor, the minutes taking apparatus including an acoustic sensor, and a processor configured to obtain a first direction of a sound source within an error range of −5 degrees to +5 degrees based on a first output signal output from the acoustic sensor and recognize a speech of a first speaker in the first direction, obtain a second direction of the sound source within the error range of −5 degrees to +5 degrees based on a second output signal output after the first output signal, and when the second direction is different from the first direction, recognize a speech of a second speaker in the second direction, and recognize voices respectively corresponding to the speech of the first speaker and the speech of the second speaker and take minutes by converting the recognized voices into text.

The processor may be further configured to recognize a change of a speaker based on the first direction or the second direction being maintained or changed with respect to continuous output signals.

The processor may be further configured to determine a similarity between a recognized voice of the first speaker and a voice of the second output signal.

The processor may be further configured to recognize the second output signal as the speech of the first speaker when the similarity is greater than a threshold value, and recognize the second output signal as the speech of the second speaker when the similarity is less than the threshold value.

According to another aspect of an example embodiment, there is provided a speaker classifying method using an acoustic sensor, the speaker classifying method including obtaining a first direction of a sound source within an error range from −5 degrees to +5 degrees based on a first output signal output from the acoustic sensor, recognizing a speech of a first speaker in the first direction, obtaining a second direction of the sound source within the error range from −5 degrees to +5 degrees based on a second output signal output after the first output signal, and recognizing, based on the second direction being different from the first direction, a speech of a second speaker in the second direction.

According to another aspect of an example embodiment, there is provided a minutes taking method using an acoustic sensor, the minutes taking method including obtaining a first direction of a sound source within an error range from −5 degrees to +5 degrees based on a first output signal output from the acoustic sensor, recognizing a speech of a first speaker in the first direction, obtaining a second direction of the sound source within the error range from −5 degrees to +5 degrees based on a second output signal output after the first output signal, recognizing a speech of a second speaker in the second direction based on the second direction being different from the first direction, recognizing voices respectively corresponding to the speech of the first speaker and the speech of the second speaker, and taking minutes by converting the recognized voices into text.

An electronic device may include the speaker classifying apparatus.

An electronic device may include the minutes taking apparatus.

### BRIEF DESCRIPTION OF THE DRAWINGS

The above and/or other aspects, features, and advantages of example embodiments of the disclosure will be more apparent from the following description taken in conjunction with the accompanying drawings, in which:

FIG. 1 illustrates an example of a directional acoustic sensor according to an example embodiment;

FIG. 2 is a cross-sectional view of a resonator illustrated in FIG. 1;

FIG. 3 is a diagram illustrating a method of adjusting directivity by using a plurality of acoustic sensors, according to a related example;

FIG. 4 is a block diagram of an apparatus including an acoustic sensor according to an example embodiment;

FIG. 5 is a diagram illustrating a directional acoustic sensor according to an example embodiment and a directional pattern of the directional acoustic sensor;

FIG. 6 is a diagram illustrating results of measurement of frequency response characteristics of a directional acoustic sensor;

FIG. 7 is a diagram illustrating results of measurement of a directional pattern of a directional acoustic sensor;

FIGS. 8A and 8B are diagrams illustrating signal processing of an acoustic sensor according to an example embodiment;

FIGS. 9A and 9B are graphs showing a result of sensing, by acoustic sensors, sound transmitted from a front direction, and sound transmitted from a rear side direction, according to an example embodiment;

FIG. 10A is a schematic diagram of a speaker classifying apparatus according to an example embodiment;

FIG. 10B is a schematic diagram of a minutes taking apparatus according to an example embodiment;

FIG. 11 is an example diagram illustrating a flow of a voice signal for speaker recognition;

FIG. 12 is a flowchart for explaining a minutes taking method according to another example embodiment;

FIG. 13 illustrates an example of a pseudo code showing a minutes taking method according to another example embodiment;

FIGS. 14A and 14B are example diagrams illustrating a similarity between speakers' speeches;

FIG. 15 is an example diagram for explaining reflecting a voice similarity in speaker recognition;

FIGS. 16 and 16B are example diagrams of a real-time minutes taking system according to another example embodiment;

FIG. 17 is a block diagram showing a schematic structure of an electronic device including a speaker classifying apparatus according to another example embodiment; and

FIGS. 18, 19, 20, and 21 are example diagrams illustrating applications of various electronic devices to which the speaker classifying apparatus or the minutes taking apparatus according to another example embodiment may be applied.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The terms used in the example embodiments below are those general terms currently widely used in the art in consideration of functions in regard to the present embodiments, but the terms may vary according to the intention of those of ordinary skill in the art, precedents, or new technology in the art. Also, specified terms may be selected arbitrarily, and in this case, the detailed meaning thereof will be described in the detailed description of the relevant example embodiment. Thus, the terms used in the example embodiments should be understood not as simple names but based on the meaning of the terms and the overall description of the embodiments.

It will also be understood that when an element is referred to as being “on” or “above” another element, the element may be in direct contact with the other element or other intervening elements may be present. The singular forms include the plural forms unless the context clearly indicates otherwise.

In the description of the example embodiments, when a portion “connects” or is “connected” to another portion, the portion contacts or is connected to the other portion not only directly but also electrically through at least one of other portions interposed therebetween.

Herein, the terms such as “comprise” or “include” should not be construed as necessarily including various elements or processes described in the specification, and it should be construed that some of the elements or the processes may not be included, or additional elements or processes may be further included.

In the description of the example embodiments, terms including ordinal numbers such as “first”, “second”, etc. are used to describe various elements but the elements should not be defined by these terms. The terms are used only for distinguishing one element from another element.

In the example embodiments, an acoustic sensor may be a microphone, and refer to an apparatus receiving a sound wave, which is a wave in air, and converting the same to an electrical signal.

In the example embodiments, an acoustic sensor assembly may be used to indicate a device including a processor for controlling an acoustic sensor or a microphone, and calculating or obtaining necessary functions. In addition, the acoustic sensor assembly may refer to an apparatus for classifying speakers or an apparatus for taking minutes of a meeting by using the acoustic sensor according to an example embodiment.

The example embodiments relate to an acoustic sensor assembly, and detailed descriptions of matters widely known to those of ordinary skill in the art to which the following embodiments belong are omitted.

In the example embodiments, speaker classification may be recognizing a plurality of speakers by using directivity information or directions of speeches.

In the example embodiments, taking minutes may be taking minutes by recognizing a plurality of speakers by using directivity information or directions of speeches of the speakers and distinguishing between speeches of the speakers and recognizing the voices of respective speakers and converting the voices into text.

Description of the following example embodiments should not be construed as limiting or defining the scope of the present disclosure, and details that are easily derivable by one of ordinary skill in the art to which the present disclosure pertains are construed as being in the scope of the embodiments. Hereinafter, example embodiments that are just for illustration are described in detail with reference to the attached drawings.

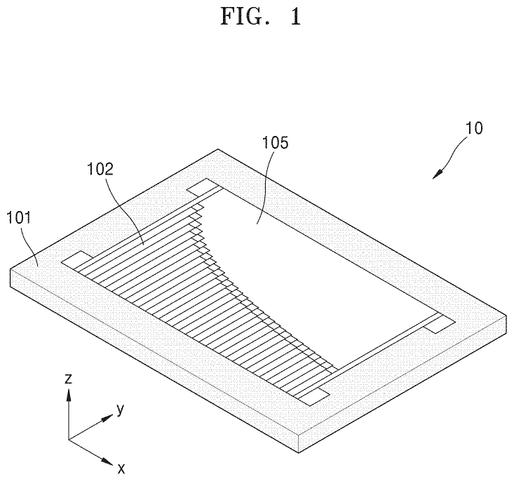

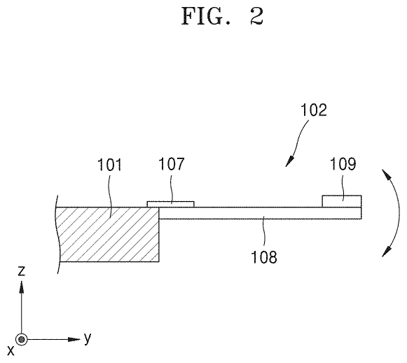

FIG. 1 illustrates an example of a directional acoustic sensor 10 according to an example embodiment. FIG. 2 is a cross-sectional view of a resonator 102 illustrated in FIG. 1.

Referring to FIGS. 1 and 2, the directional acoustic sensor 10 may include a support 101 and a plurality of resonators 102. A cavity 105 may be formed in the support 101 to pass through the support 101. As the support 101, for example, a silicon substrate may be used, but is not limited thereto.

The plurality of resonators 102 may be arranged in the cavity 105 of the support 101 in a certain form. The resonators 102 may be arranged two-dimensionally without overlapping each other. As illustrated in FIG. 2, an end of each of the resonators 102 may be fixed to the support 101, and the other end thereof may extend toward the cavity 105. Each of the resonators 102 may include a driving unit 108 moving by reacting to input sound and a sensing unit 107 sensing a movement of the driving unit 108. Also, the resonators 102 may further include a mass body 109 for providing a certain mass to the driving unit 108.

The resonators 102 may be provided to sense, for example, acoustic frequencies of different bands. For example, the resonators 102 may be provided to have different center frequencies or resonance frequencies. To this end, the resonators 102 may be provided to have different dimensions from each other. For example, the resonators 102 may be provided to have different lengths, widths or thicknesses from each other.

Dimensions, such as widths or thicknesses of the resonators 102, may be set by considering a desired resonance frequency with respect to the resonators 102. For example, the resonators 102 may have dimensions, such as a width from about several pm to several hundreds of μm, a thickness of several μm or less, and a length of about several mm or less. The resonators 102 having fine sizes may be manufactured by a micro electro mechanical system (MEMS) process.

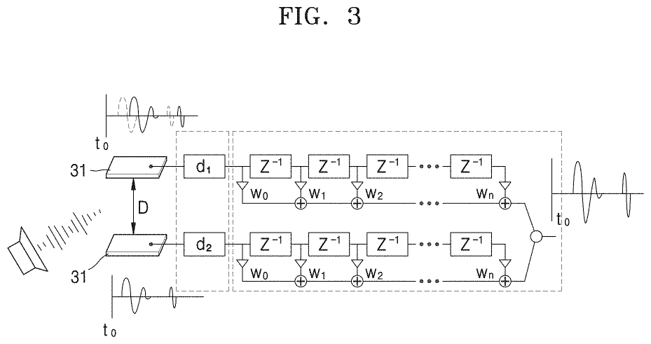

FIG. 3 is a diagram illustrating a method of adjusting directivity by using a plurality of acoustic sensors, according to a related example. Referring to FIG. 3, in a method of adjusting directivity by using a plurality of acoustic sensors 31, the plurality of acoustic sensors 31 may be used to hear sound in a particular direction louder. The plurality of acoustic sensors 31 may be arranged apart at a certain distance D, and a time or phase delay that sound reaches each acoustic sensor 31 is caused due to the distance D, and the overall directivity may be adjusted by varying the degrees of compensating for the time or phase delay.

Hereinafter, an efficient structure and operation of a speaker classifying apparatus and a minutes taking apparatus according to the present disclosure are described in detail with reference to the drawings.

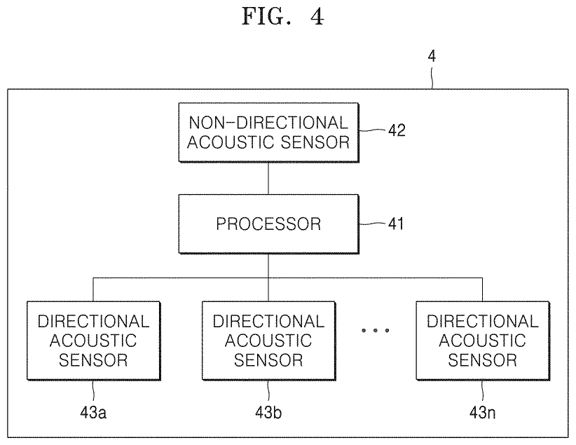

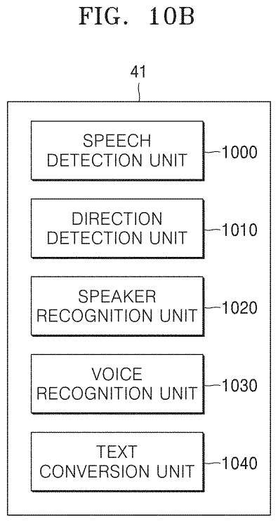

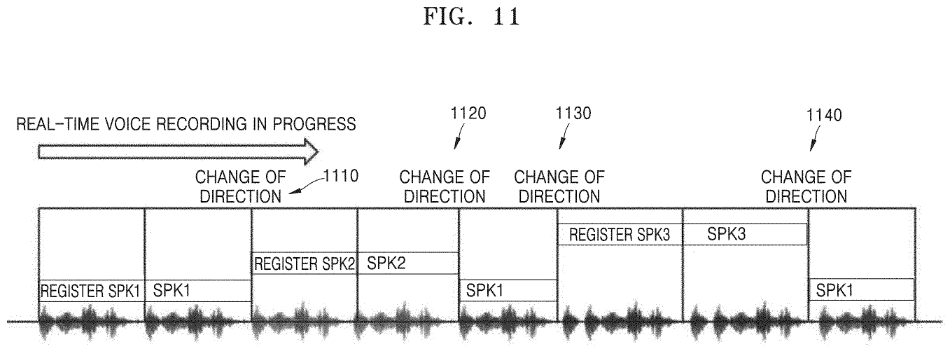

FIG. 4 is a block diagram of an apparatus including an acoustic sensor, according to an example embodiment. Here, the apparatus may be a speaker classifying apparatus that classifies a plurality of speakers by using an acoustic sensor, or a minutes taking apparatus for taking minutes by classifying a plurality of speakers by using an acoustic sensor, recognizing the voice of each speaker, and converting the voice into text. Functions thereof will be described in detail with reference to FIGS. 10A and 10B, and with reference to FIG. 4, an acoustic sensor and a processor will be mainly described.

Referring to FIG. 4, an apparatus 4 may include a processor 41, a non-directional acoustic sensor 42, and a plurality of directional acoustic sensors 43a, 43b, 43n. The apparatus 4 may obtain sound around the apparatus 4 by using the processor 41, the non-directional acoustic sensor 42, and the plurality of directional acoustic sensors 43a, 43b, 43n.

The non-directional acoustic sensor 42 may sense sound in all directions surrounding the non-directional acoustic sensor 42. The non-directional acoustic sensor 42 may have directivity for uniformly sensing sound in all directions. For example, the directivity for uniformly sensing sound in all directions may be omni-directional or non-directional.

The sound sensed using the non-directional acoustic sensor 42 may be output as a same output signal from the non-directional acoustic sensor 42, regardless of a direction in which the sound is input. Accordingly, a sound source reproduced based on the output signal of the non-directional acoustic sensor 42 may not include information on directions.

A directivity of an acoustic sensor may be expressed using a directional pattern, and the directional pattern may refer to a pattern indicating a direction in which an acoustic sensor may receive a sound source.

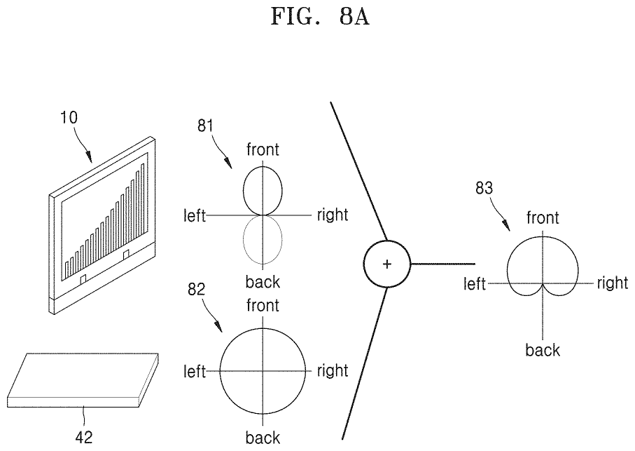

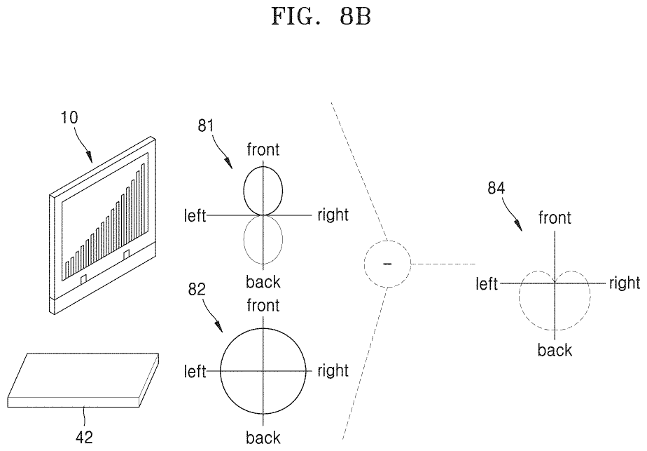

A directional pattern may be illustrated to identify sensitivity of an acoustic sensor according to a direction in which sound is transmitted based on a 360° space surrounding the acoustic sensor having the directional pattern. For example, a directional pattern of the non-directional acoustic sensor 42 may be illustrated in a circle to indicate that the non-directional acoustic sensor 42 has the same sensitivity to sounds transmitted 360° omni-directionally. A specific application of the directional pattern of the non-directional acoustic sensor 42 will be described later with reference to FIGS. 8A and 8B.

Each of the plurality of directional acoustic sensors 43a, 43b, 43n may have a same configuration as the directional acoustic sensor 10 illustrated in FIG. 1 described above. The plurality of directional acoustic sensors 43a, 43b, 43n may sense sound from a front (e.g., +z direction in FIG. 1) and a rear side (e.g., −z direction of FIG. 1). Each of the plurality of directional acoustic sensors 43a, 43b, 43n may have directivity of sensing sounds from the front and the rear side. For example, directivity for sensing sounds from a front direction and a rear side direction may be bi-directional.

The plurality of directional acoustic sensors 43a, 43b, 43n may be arranged adjacent to and to surround the non-directional acoustic sensor 42. The number and arrangement of directional acoustic sensors 43a, 43b, 43n will be described later in detail with reference to FIG. 10.

The processor 41 controls the overall operation of the apparatus 4 and performs signal processing. The processor 41 may select at least one of output signals of acoustic sensors having different directivities, thereby calculating an acoustic signal having a same directivity as those of the non-directional acoustic sensor 42 and the plurality of directional acoustic sensors 43a, 43b, 43n. An acoustic signal having a directional pattern of an acoustic sensor corresponding to an output signal selected by the processor 41 may be calculated based on the output signal selected by the processor 41. For example, the selected output signal may be identical to the acoustic signal. The processor 41 may adjust directivity by selecting a directional pattern of the apparatus 4 as a directional pattern of an acoustic sensor corresponding to the selected output signal, and may reduce or loudly sense sound transmitted in a certain direction according to situations.

An acoustic signal refers to a signal including information about directivity, like output signals of the non-directional acoustic sensor 42 and the plurality of directional acoustic sensors 43a, 43b, 43n, and some of the output signals may be selected and determined as acoustic signals or may be newly calculated based on calculation of some of the output signals. A directional pattern of an acoustic signal may be in a same shape as directional patterns of the non-directional acoustic sensor 42 and the plurality of directional acoustic sensors 43a, 43b, 43n or in a different shape, and have a same or different directivity. For example, there is no limitation on a directional pattern or directivity of an acoustic signal.

The processor 41 may obtain output signals of the non-directional acoustic sensor 42 and/or the plurality of directional acoustic sensors 43a, 43b, 43n, and may calculate an acoustic signal having a different directivity from those of the non-directional acoustic sensor 42 and the plurality of directional acoustic sensors 43a, 43b, 43n included in the apparatus 4 by selectively combining the obtained output signals. For example, the processor 41 may calculate an acoustic signal having a different directional pattern from directional patterns of the non-directional acoustic sensor 42 and the plurality of directional acoustic sensors 43a, 43b, 43n. The processor 41 may calculate an acoustic signal having a directional pattern oriented toward a front of a directional acoustic sensor (e.g., 43a), depending on the situation.

The processor 41 may calculate or obtain an acoustic signal by calculating at least one of a sum of and a difference between certain ratios of an output signal of the non-directional acoustic sensor 42 and output signals of the plurality of directional acoustic sensors 43a, 43b, 43n.

The processor 41 may obtain sound around the apparatus 4 by using an acoustic signal. The processor 41 may obtain ambient sound by distinguishing a direction of a sound transmitted to the apparatus 4 by using an acoustic signal. For example, when the processor 41 records a sound source transmitted from the right side of the apparatus 4 and provides the recorded sound source to a user, the user may hear the sound source as if the sound source is coming from the right side of the user. When the processor 41 records a sound source circling the apparatus 4 and provides the recorded sound source to the user, the user may hear the sound source as if the sound source is circling the user.

The processor 41 may obtain a first direction of a sound source within an error range of −5 degrees to +5 degrees based on a first output signal output from an acoustic sensor, and recognize a speech of a first speaker in the first direction, and obtain a second direction of the sound source within the error range of −5 degrees to +5 degrees based on a second output signal output after the first output signal, and when the second direction is different from the first direction, the processor 41 may recognize a speech of a second speaker in the second direction. Here, a criterion for determining whether the first direction is different from the second direction may be whether the range of +5 degrees is deviated or not. For example, when the first direction is 30 degrees, and the second direction is 36 degrees, it may be determined that the first direction is different from the second direction. However, the criterion for determining whether detected directions are the same or different is not limited thereto, and may be appropriately defined according to applications and specifications of an apparatus.

In addition, the processor 41 may obtain a first direction of a sound source within an error range of −5 degrees to +5 degrees based on a first output signal output from an acoustic sensor, and recognize a speech of a first speaker in the first direction, and obtain a second direction of the sound source within the error range of −5 degrees to +5 degrees based on a second output signal output after the first output signal. When the second direction is different from the first direction, the processor 41 may recognize a speech of a second speaker in the second direction, and may take minutes by recognizing voices respectively corresponding to the speech of the first speaker and the speech of the second speaker, and converting recognized voices into text.

The processor 41 may estimate a direction of a sound source by using various algorithms according to the number and arrangement of directional acoustic sensors.

The processor 41 may include a single processor core (single-core) or a plurality of processor cores (multi-core). The processor 41 may process or execute programs and/or data stored in a memory. In some example embodiments, the processor 41 may control a function of the apparatus 4 by executing programs stored in a memory. The processor 41 may be implemented as a central processing unit (CPU), a graphics processing unit (GPU), an application processor (AP), or the like.

The processor 41 may detect a direction of a sound source by using various methods. The method of adjusting directivity, by a directional acoustic sensor, may be referred to as time difference of arrival (TDOA).

However, the above method is based on the assumption that there is a difference in times that sound reaches each acoustic sensor. Therefore, there may be a restriction on setting a distance between acoustic sensors as the distance needs to be set by considering a wavelength of an audible frequency band. The restriction on setting a distance between acoustic sensors may also limit providing a compact size of a device performing the above method. In particular, as a low frequency has a longer wavelength, to distinguish a sound of a low frequency, a distance between acoustic sensors needs to be relatively broad and a signal-to-noise ratio (SNR) of each acoustic sensor needs to be relatively high. Moreover, as phases differ according to frequency bands of sound sensed by each acoustic sensor in the TDOA, the phases may have to be compensated for with respect to each frequency band. In order to compensate for the phase of each frequency, a complex signal processing process of applying an appropriate weight to each frequency may be necessary in the method described above.

In addition, to estimate a direction of a sound source by using TDOA, a signal in an array of a plurality of non-directional microphones is frequently used. A time delay between signals obtained by each microphone may be calculated, and a direction from which a sound source came is estimated based on the time delay. However, the accuracy of the direction estimation is dependent on the size of the array (distance between the microphones) and the time delay.

Another method is to estimate a direction of a sound source based on the intensity difference. This method uses a difference between intensities or levels measured by each microphone to estimate a direction. From which direction a sound source came may be determined based on the magnitude of a signal measured in a time domain. As a size difference between each microphone is used, gain calibration is to be done very accurately, and a large number of microphones may be needed to improve performance.

When using the TDOA-based direction estimation method, the principle of generating a difference in phases between the microphones for each frequency of a sound source according to the size of the microphone array is utilized. Therefore, the size of the array and a wavelength of a sound source to be estimated have a physical relationship, and the size of the array determines the direction estimation performance.

A method of utilizing a time difference or intensity difference between microphones requires a large number of microphones by increasing a size of the array in order to improve the direction estimation performance. In addition, in the time difference-based estimation method, a digital signal processing device is required to calculate different time delays and phase differences for each frequency, and the performance of the device may also be a factor that limits the direction estimation performance.

In addition, as a direction estimation method using an acoustic sensor, a direction estimation algorithm using a directional/non-directional microphone array may be used. For example, by using a channel module including one non-directional microphone and a plurality of, or at least two, directional microphones, a direction of a sound source coming from 360 degrees omni-directionally is detected. In an example embodiment, by utilizing the fact that a directional shape of a directional microphone is figure-of −8, regardless of frequency, a direction of a sound source may be estimated based on power of the sound source. Therefore, the direction of the sound source may be estimated by using an array having a small size, for example, an array within 3 cm, and with a relatively high accuracy, and voice separation based on spatial information may also be performed.

In an example embodiment, a direction of a speaker or a sound source may be detected through an acoustic sensor, for example, a non-directional acoustic sensor, a directional acoustic sensor, or a combination of a non-directional acoustic sensor and a plurality of directional acoustic sensors. Here, the detected direction may be detected with accuracy having an error range of −5 degrees to +5 degrees. Hereinafter, direction detection based on a directional acoustic sensor or a combination of a non-directional acoustic sensor and a directional acoustic sensor and generation of an output signal having directivity are described, but embodiments are not limited thereto, and other various direction detection methods may also be applied.

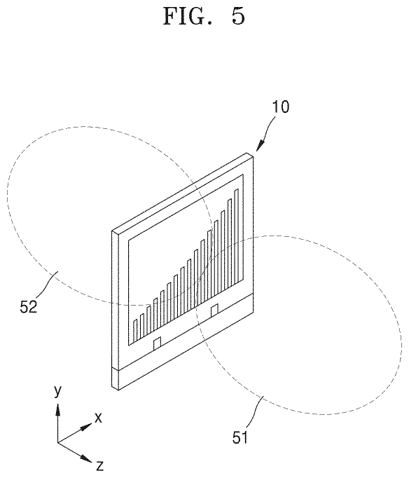

FIG. 5 is a diagram illustrating a directional acoustic sensor according to an example embodiment and a directional pattern of the directional acoustic sensor. Referring to FIG. 5, the directional acoustic sensor 10 may include bi-directional patterns 51 and 52. For example, the bi-directional patterns 51 and 52 may include figure-8 type directional patterns including a front portion 51 oriented toward a front of the directional acoustic sensor 10 (+z direction) and a rear side portion 52 oriented toward a rear side of the directional acoustic sensor 10 (−z direction).

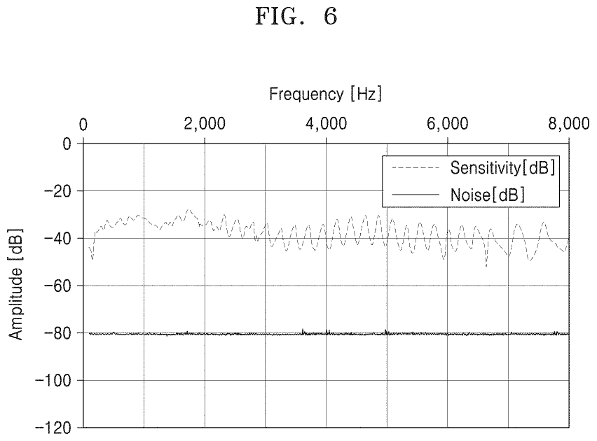

FIG. 6 is a diagram illustrating results of measurement of frequency response characteristics of the directional acoustic sensor 10. Referring to FIG. 6, the directional acoustic sensor 10 has uniform sensitivity with respect to various frequencies. In a frequency range from 0 Hz to 8000 Hz, sensitivity marked by a dashed line is uniformly at −40 dB, and noise marked by a solid line is at −80 dB. The directional acoustic sensor 10 has uniform sensitivity with respect to various frequencies, and may thus uniformly sense sounds of the various frequencies.

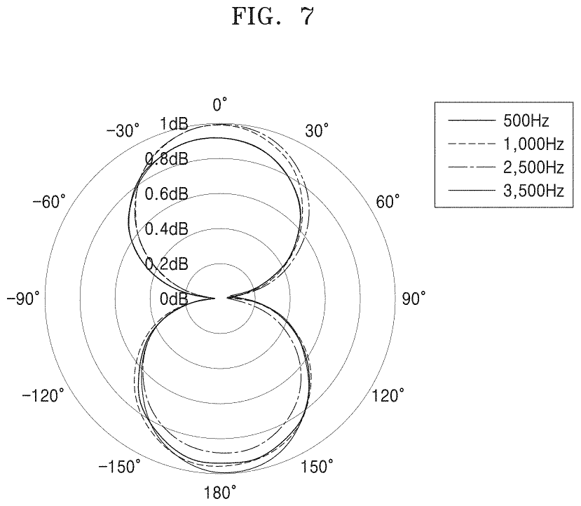

FIG. 7 is a diagram illustrating results of measurement of a directional pattern of the directional acoustic sensor 10. As illustrated in FIG. 7, the directional acoustic sensor 10 has a uniform, bi-directional pattern with respect to various frequencies. For example, the directional acoustic sensor 10 has directivity in a +z axis direction and a −z axis direction of FIG. 1, which are respectively a 0-degree direction and a 180-degree direction.

FIG. 8A is a diagram illustrating signal processing of a direction estimating apparatus according to an example embodiment. Referring to FIG. 8A, the processor 41 may calculate an acoustic signal by calculating at least one of a sum of and a difference between certain ratios of an output signal of the non-directional acoustic sensor 42 and an output signal of the directional acoustic sensor 10. An acoustic signal may include a digital signal calculated based on output signals so that the acoustic signal has a different shape or a different directivity from those of direction patterns (a bi-directional pattern 81 and an omni-directional pattern 82) of the directional acoustic sensor 10 and the non-directional acoustic sensor 42. For example, in a calculation to calculate an acoustic signal, when an output signal of the non-directional acoustic sensor 42 is G1, an output signal of the directional acoustic sensor 10 is G2, and a ratio of the output signal G2 of the directional acoustic sensor 10 to the acoustic signal G1 of the non-directional acoustic sensor 42 is 1:k, a sum of certain ratios between the output signals G1 and G2 may be calculated using a formula of G1+kG2, and a difference between the certain ratios of the output signals G1 and G2 may be calculated using a formula of G1−kG2. A ratio of each of the output signals may be preset according to a shape or directivity of a required, appropriate directional pattern.

The processor 41 may calculate an acoustic signal having a directional pattern oriented toward the front direction of the directional acoustic sensor 10 (e.g., +z direction of FIG. 5) by calculating a sum of certain ratios of an output signal of the non-directional acoustic sensor 42 and an output signal of the directional acoustic sensor 10.

The non-directional acoustic sensor 42 is oriented in all directions, and thus, there may be no difference in output signals regardless of a direction in which sound is transmitted. However, for convenience of description below, the front direction of the directional acoustic sensor 10 will be assumed to be identical to a front direction of the non-directional acoustic sensor 42.

For example, the processor 41 may calculate an acoustic signal having a uni-directional pattern 83 by calculating a sum of 1:1 ratios of an output signal of the non-directional acoustic sensor 42 and an output signal of the directional acoustic sensor 10. The uni-directional pattern 83 may have a directivity facing the front of the directional acoustic sensor 10. However, the uni-directional pattern 83 may include a directional pattern covering a broader range to the left and the right, compared to a front portion of the bi-directional pattern 81. For example, the uni-directional pattern 83 may include a cardioid directional pattern.

The directional acoustic sensor 10 may include the bi-directional pattern 81, and the non-directional acoustic sensor 42 may include the omni-directional pattern 82. The directional acoustic sensor 10 may sense a sound that is in-phase with a phase of a sound sensed by the non-directional acoustic sensor 42 from a front direction of the bi-directional pattern 81 (e.g., +z direction of FIG. 5), and a sound that is anti-phase with a phase of a sound sensed by the non-directional acoustic sensor 42 from a rear side direction of the bi-directional pattern 81 (e.g., −z direction of FIG. 5).

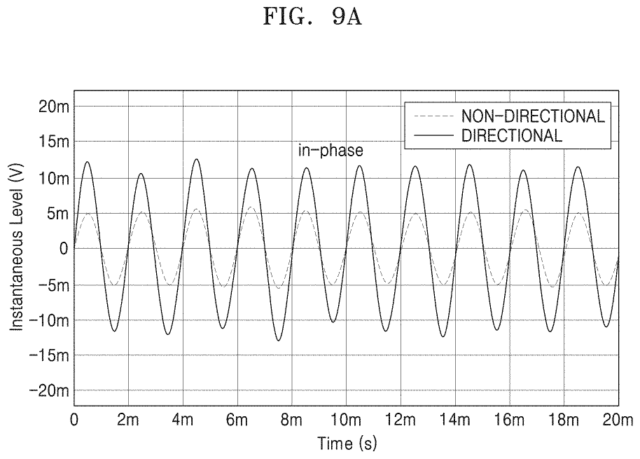

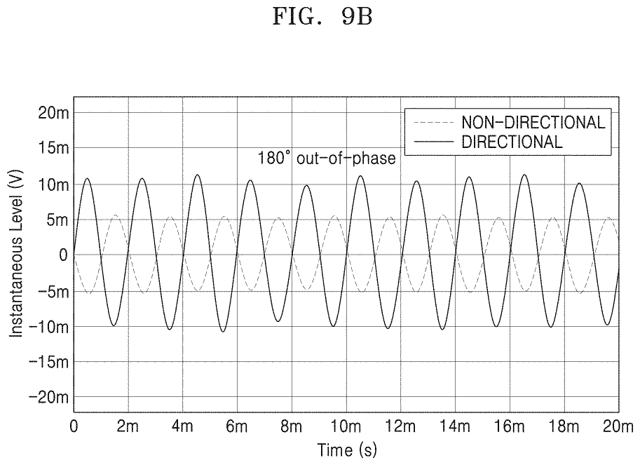

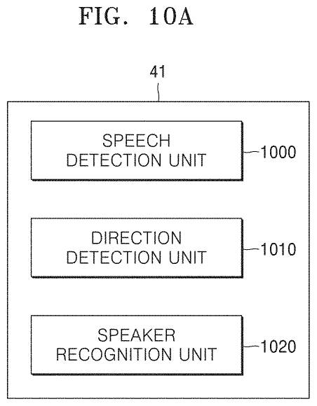

FIG. 9A is a graph showing a result of sensing sound transmitted from a front direction, by acoustic sensors, according to an example embodiment. FIG. 9B is a graph showing a result of sensing sound transmitted from a rear side direction, by acoustic sensors, according to an example embodiment.

Referring to FIGS. 9A and 9B, a sound transmitted from the front direction of the directional acoustic sensor 10 and sound transmitted from the front direction of the non-directional acoustic sensor 42 are in-phase with each other, and the sound transmitted from the front direction of the directional acoustic sensor 10 and sound transmitted from the rear side direction of the non-directional acoustic sensor 42 have a phase difference of 180° from each other such that peaks and troughs alternately cross each other.

Referring back to FIG. 8A, sounds transmitted from the front direction are in-phase with each other, and sounds transmitted from the rear side direction are in anti-phase with each other, and thus, some of the output signals are added and some others are offset and an acoustic signal having the uni-directional pattern 83 oriented in the front direction may be calculated, accordingly.

FIG. 8B is a diagram illustrating signal processing of a direction estimating apparatus according to an example embodiment. Referring to FIG. 8B, the processor 41 may calculate an acoustic signal having a directional pattern oriented toward the rear side direction of the directional acoustic sensor 10 (e.g., −z direction of FIG. 5) by calculating a difference between certain ratios of an output signal of the non-directional acoustic sensor 42 and an output signal of the directional acoustic sensor 10.

For example, the processor 41 may calculate an acoustic signal having a uni-directional pattern 84 by calculating a difference between 1:1 ratios of an output signal of the non-directional acoustic sensor 42 and an output signal of the directional acoustic sensor 10. Opposite to the uni-directional pattern 83 of FIG. 8A, the uni-directional pattern 84 may have a directivity facing a rear surface of the directional acoustic sensor 10. The uni-directional pattern 84 may include a directional pattern covering a broader range to the left and the right, compared to a rear side portion of the bi-directional pattern 81. For example, the uni-directional pattern 83 may be a cardioid directional pattern.

While a method of calculating an acoustic signal having a uni-directional pattern by calculating a sum of or a difference between an output of the directional acoustic sensor 10 and an output of the non-directional acoustic sensor 42 is described above, this is merely an example, and the control of directivity is not limited to the method described above.

The processor 41 may calculate an acoustic signal having a new bi-directional pattern differing from bi-directivity of respective directional acoustic sensors by selecting only a non-directional pattern, or selecting only a bi-directional pattern of a directional acoustic sensor oriented toward a certain direction, or calculating output signals of directional acoustic sensors, according to situations.

Example embodiments related to speaker classification for classifying speakers by using an acoustic sensor and taking of minutes based on the same. According to related art, in order to automatically take minutes, a method of recording the entire meeting and performing speaker diarization to perform speaker verification on each speech is used. Various methods from general principal components analysis (PCA) to deep learning methods are used. In the method according to related art, when there is a recording signal of all the minutes, speeches may be classified by finding disconnections in the speeches through the speaker diarization technique, and speeches may be classified for each speaker through the speaker verification technique.

The method according to related art involves processing data after acquiring all data, and thus has a security risk. From the standpoint of providing a service, data is sent to a cloud for computation to reduce deviations for each device, guarantee performance, and protect their own algorithm. For this reason, security-conscious companies and users may be reluctant to send their minutes to a server of other companies. In addition, even when an algorithm is made lightweight and applied in an on-device form, the algorithm is still additionally used, and thus, the overall system becomes heavy. Finally, the algorithm according to related art has a problem that the number of participants needs to be decided by a human.

To address the problems of taking minutes according to related art described above, the example embodiments provide a method of automatically classifying speakers by using directivity information or direction information of an acoustic sensor and enabling to take minutes in real time based on the classification.

FIG. 10A is a schematic diagram of a speaker classifying apparatus according to an example embodiment.

Referring to FIG. 10A, a speaker classifying apparatus 41 may include a speech detection unit 1000, a direction detection unit 1010, and a speaker recognition unit 1020. The speaker classifying apparatus 41 may be the processor 41 illustrated in FIG. 4, and may include the acoustic sensor illustrated in FIG. 4, and the acoustic sensor may be a non-directional acoustic sensor, a directional acoustic sensor, or a combination thereof. In an example embodiment, speakers may be distinguished from each other based on a direction by recognizing directivity information, for example, a direction from which a voice is coming. Accordingly, a speaker may be distinguished based on a direction of a speech, even when information of the speaker is not known.

The speech detection unit 1000 detects that a voice is coming and travelling in a state of silence around the acoustic sensor.

The direction detection unit 1010 detects a direction from which a voice is coming, by using directivity information or direction information of the acoustic sensor. Here, the direction may be detected based on directivity information of an output signal output from the acoustic sensor. As described above, for direction detection by an acoustic sensor, a TDOA-based direction estimation technique, a direction estimation technique using a combination of a non-directional acoustic sensor and a plurality of directional acoustic sensors, and the like, may be used, but embodiments are not limited thereto.

The speaker recognition unit 1020 classifies speakers by labeling directions.

FIG. 11 is an example diagram illustrating a flow of a voice signal for speaker recognition.

Referring to FIG. 11, real-time voice recording being in progress is illustrated, and for the sake of convenience, a first column from the left in the drawing is described as a first output signal from an acoustic sensor, and a next, second column thereto on the right is described as a second output signal.

When a voice corresponding to the first output signal is input, a direction of the first output signal, for example, 30 degrees, is detected, and the detected direction, 30 degrees, is registered as Speaker 1 (SPK1). In a next signal, it is determined that the voice of Speaker 1 is input from the 30 degree-direction. When a direction of a third output signal is changed (1110), that is, when a 90 degree-direction is detected in the third output signal, Speaker 2 (SPK 2) is registered. When a direction of a fourth output signal is still 90 degrees, it is determined that the voice of Speaker 2 is input. When a direction of a fifth output signal is changed (1120), and the fifth output signal is in the 30 degrees-direction, it is determined that the voice of Speaker 1 is input again. When a direction of a sixth output signal is changed (1130), and the sixth output signal is detected in a 180 degrees-direction, Speaker 3 (SPK 3) is registered. When a direction of a seventh output signal is still 180 degrees, it is determined that the voice of Speaker 3 is input. When a direction of an eighth output signal is changed (1140), and the eighth output signal is in the 30 degrees-direction, it is determined that the voice of Speaker 1 is input again.

In an example embodiment, speakers may be distinguished by using only directivity information of an acoustic sensor, and it is possible to classify the speakers without undergoing a complicated calculation or post-processing at the server's end. Therefore, embodiments of the present disclosure may be more effectively applied to searching for a certain sound or a certain person's voice.

FIG. 10B is a schematic diagram of a minutes taking apparatus according to an example embodiment.

Referring to FIG. 10B, a minutes taking apparatus 41 includes a speech detection unit 1000, a direction detection unit 1010, a speaker recognition unit 1020, a voice recognition unit 1030, and a text conversion unit 1040. The minutes taking apparatus 41 may be the processor 41 illustrated in FIG. 4, and may include the acoustic sensor illustrated in FIG. 4, and the acoustic sensor may be a non-directional acoustic sensor, a directional acoustic sensor, or a combination thereof. In an example embodiment, by recognizing directivity information, that is, a direction from which a voice is coming, speakers may be classified based on the direction, and then the voice of all speakers may be recognized and converted into text to take minutes in real time. Since the speaker classification described with reference to FIG. 10A is equally applied here, description will focus only additional configurations.

The voice recognition unit 1030 recognizes a voice with respect to an output signal output from the acoustic sensor. Here, as described with reference to FIG. 10A, voice signals distinguished for each speaker may be distinguished from each other and recognized.

The voice recognition unit 1030 may include three steps of pre-processing, pattern recognition, and post-processing in order to receive a voice signal and calculate the same in the form of a sentence and to implement the same. Through pre-processing and feature extraction, noise is removed and features are extracted from a voice signal, and features are recognized in the form of elements necessary to construct a sentence. The elements are combined and expressed in the form of sentences.

The pre-processing process is a process of extracting features in a time domain and a frequency domain from a voice signal as in transformation and feature extraction auditory systems. The pre-processing process functions as the cochlea of the auditory system and includes extracting information about periodicity and synchronization of voice signals.

In the pattern recognition process, phonemes, syllables, and words, which are elements necessary to construct a sentence, are recognized based on the features obtained through pre-processing of a resultant value calculation voice signal. To this end, a variety of template (for example, dictionary)-based algorithms such as phonetics, phonology, phonological arrangement theory, and prosodic requirements may be used. For example, a pattern recognition process may include an approach through dynamic programming (dynamic time warping (DTW)), an approach through probability estimation (hidden Markov model (HMM)), an approach through inference using artificial intelligence, an approach through pattern classification, and the like.

The post-processing process includes restoring a sentence by reconstructing phonemes, syllables, and words that are results of language processing (sentence restoration) pattern recognition. To this end, syntax, semantics, and morphology are used. To construct a sentence, rules-based and statistics-based models are used. According to a syntactic model, sentences are constructed by limiting the types of words that can come after each word, and according to a statistical model, sentences are recognized by considering the probability of the occurrence of N words before each word.

The text conversion unit 1040 converts recognized voice into text to take minutes. The text conversion unit 1040 may be a speech-to-text (STT) module. In addition, text may be output together with labeling for each speaker recognized by the speaker recognition unit 1020 or may be output together with time information, to be suitable for minutes.

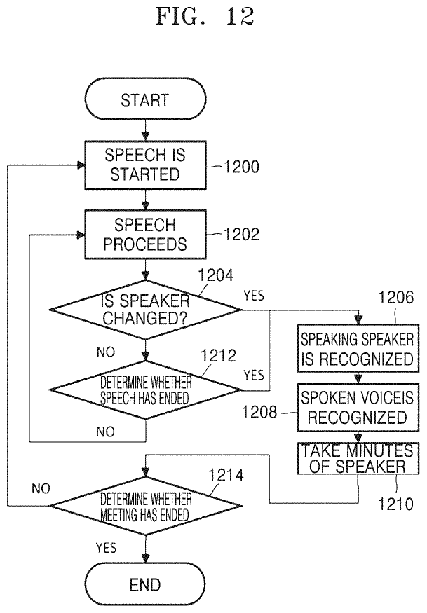

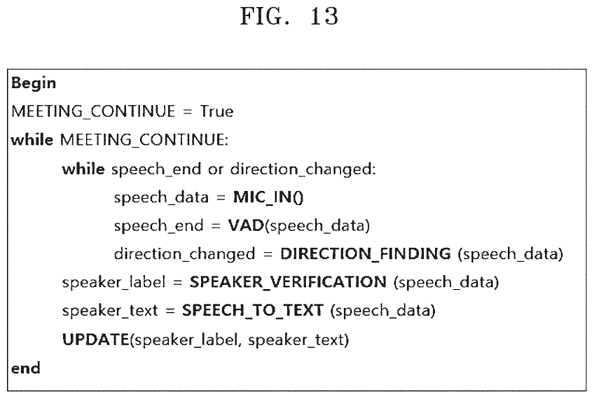

FIG. 12 is a flowchart for explaining a minutes taking method according to another embodiment.

Referring to FIG. 12, in operation 1200, a speech is started. In operation 1202, while the speech proceeds, in operation 1204, whether a speaker is changed is determined. In operation 1204, when the speaker is changed, in operation 1206, a speaking speaker is recognized, and in operation 1208, the spoken voice is recognized. In operation 1210, minutes of the speaking speaker are taken. In operation 1214, it is determined whether a meeting is over, and if the meeting is not over, the method returns to operation 1200.

In operation 1204, when the speaker is not changed, in operation 1212, it is determined whether the speech has ended. When the speech has ended, the method proceeds to operation 1206 to perform speaker recognition, voice recognition, and minutes taking.

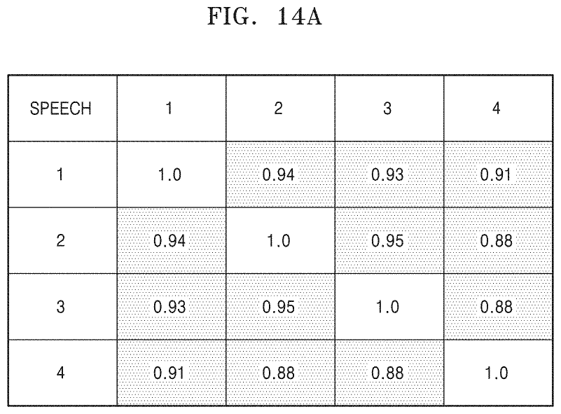

FIG. 13 illustrates an example of a pseudo code showing a minutes taking method according to another example embodiment.

As directivity information may be known through an acoustic sensor in the minutes taking method according to the example embodiment, positions of persons who are speaking may be known, and speaker diarization and speaker classification may be performed based on the positions of speaking persons. For example, the problem of related art may be addressed by asking “Is the speaker changed?” Speakers may be distinguished from each other while recording is conducted in real time, and thus, a security risk in terms of recording everything and performing post-processing on a server as in the related art may be avoided, and there is no need to perform algorithms such as speaker diarization and speaker verification, and thus, there is an advantage in terms of computation and complexity.

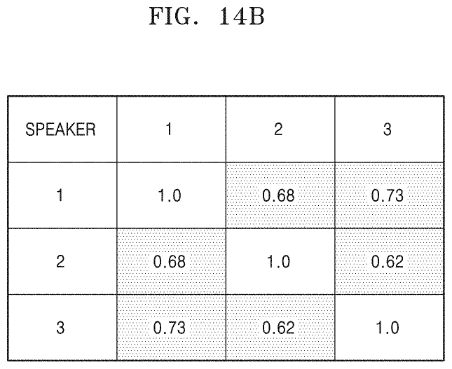

FIGS. 14A and 14B are example diagrams illustrating a similarity between speakers' speeches.

FIG. 14A illustrates a similarity between speeches of one speaker, and FIG. 14B illustrates a similarity of speeches among three speakers. In an example embodiment, when determining a change of a speaker, that is, whether the speaker is changed, in addition to a change in direction, the similarity of a previously recognized voice is reflected, along with the change of direction, and when the similarity is greater than or equal to a threshold value, for example, 80%, it is determined that the speaker is a previous speaker and when the similarity is less than 80%, the speaker is determined to be a new speaker.

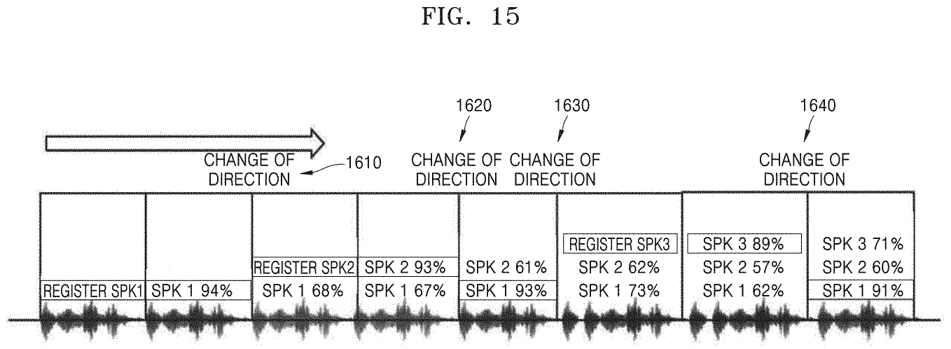

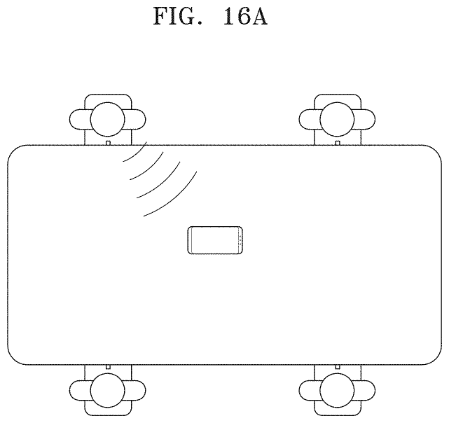

FIG. 15 is an example diagram for explaining reflecting a voice similarity in speaker recognition. A criterion of the similarity of the example embodiment described with reference to FIG. 15 is as follows. Whether the same speaker is speaking or the speaker is changed is determined based on a threshold value of 80%, and a speaker with a greatest probability is searched for, and when the probability of the corresponding speaker is 80% or more, the speaker is registered as the existing speaker, and when not, the speaker is registered as a new speaker.

Referring to FIGS. 14A and 14B and FIG. 15 together, as in FIG. 11, a state in which real-time voice recording is in progress is shown, and for convenience, a first column from the left illustrated in the drawing is described as a first output signal from the acoustic sensor, and a next second column is described as a second output signal.

FIG. 15 shows a case in which a first speaker (SPK 1) is registered from the first output signal, and a similarity between the first output signal and the second output signal is 94%. Accordingly, it is determined that the second output signal is that of a voice of the first speaker. Here, the similarity may be calculated by extracting a feature vector of an output signal and then calculating a cosine similarity. The similarity may also be performed using various methods for determining a similarity between voice signals.

When a direction of the third output signal is changed (1610), a second speaker (SPK2) is registered. Here, since a similarity between the first output signal or the second output signal and the third output signal of the first speaker is 68%, it can be confirmed that the speaker is changed. The fourth output signal is input, and a similarity with the third output signal is 93% with respect to the second speaker and 67% with respect to the first speaker.

When a direction of the fifth output signal is changed (1620), the direction of the fifth output signal is the same as that of the first output signal. Moreover, the fifth output signal has a similarity of 93% with respect to the first speaker and a similarity of 61% with respect to the second speaker.

When a direction of the sixth output signal is changed (1630), and the direction of the sixth output signal is a new direction different from the direction of the first speaker and the second speaker, a third speaker (SPK 3) is registered. A similarity between the sixth output signal and the first speaker is 73%, and a similarity with the second speaker is 62%. A direction of the seventh output signal is not changed, a similarity with the third speaker is 89%, the similarity with the second speaker is 57%, and the similarity with the first speaker is 62%. Therefore, it may be determined that the seventh output signal is that of a voice of the third speaker.

When a direction of the eighth output signal is changed (1640), the eight output signal is in the same direction as the first speaker, a similarity thereof with the first speaker is 91%, a similarity thereof with the third speaker is 71%, and a similarity thereof with the second speaker is 60%.

In an example embodiment, when the voice of a series of meetings is recorded, not only speakers may be classified but similarity between the speakers may be determined, thereby increasing the accuracy of speaker classification.

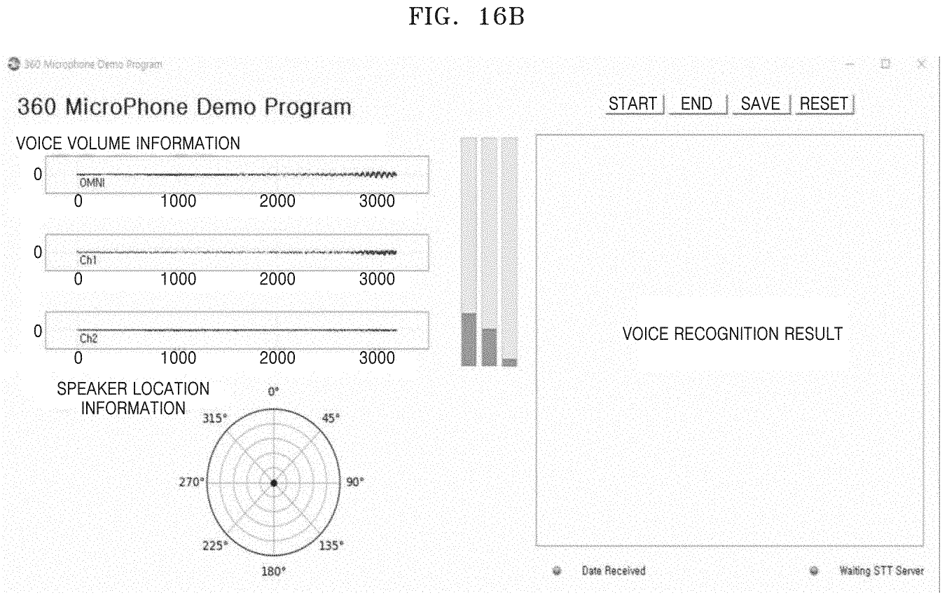

FIGS. 16A and 16B are example diagrams of a real-time minutes taking system according to another example embodiment.

Referring to FIG. 16A, a scene in which a smartphone, which is an example of a minutes taking apparatus according to an example embodiment, is placed on a table, and four participants are having a meeting is illustrated.

Referring to FIG. 16B, a screen in which a minutes taking method according to an example embodiment is implemented as a program is illustrated. The program may be implemented as an application on a personal computer (PC), television (TV), or smartphone. As illustrated in the drawing, information on the volume of the voice may be displayed on the upper left, location information of speakers may be displayed on the bottom left, and a voice recognition result may be displayed on the right. In addition, menus for minutes taking, for example, meeting start, meeting end, save, reset, and the like, may be displayed on the upper right menu. As illustrated in the drawing, when a direction in which a sound is coming is detected and the direction is changed, a speaker may be registered in speaker location information, and when the speaker is registered, a result of voice recognition according to the speaker's speech may be displayed.

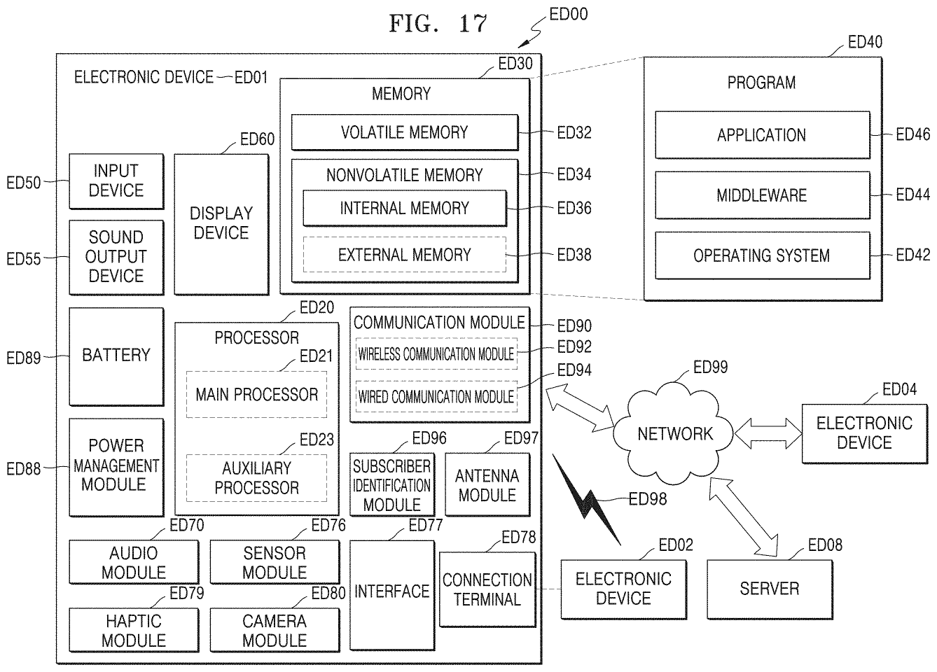

FIG. 17 is a block diagram illustrating a schematic structure of an electronic device including a speaker classifying apparatus or a minutes taking apparatus, according to another example embodiment.

The speaker classifying apparatus or the minutes taking apparatus described above may be used in various electronic devices. The electronic devices may include, for example, a smartphone, a portable phone, a mobile phone, a personal digital assistant (PDA), a laptop, a PC, various portable devices, home appliances, security cameras, medical cameras, automobiles, and Internet of Things (loT) devices, or other mobile or non-mobile computing devices, and are not limited thereto.

The electronic devices may further include an AP, and may control a plurality of hardware or software components by driving an operating system or an application program through the processor, and may perform various data processing and computation. The processor may further include a GPU and/or an image signal processor.

Referring to FIG. 17, in a network environment ED00, an electronic device ED01 may communicate with another electronic device ED02 through a first network ED99 (e.g., a short-range wireless communication network) or may communicate with another electronic device ED04 and/or a server ED08 through a second network ED99 (e.g., a remote wireless communication network, etc.). The electronic device ED01 may communicate with the electronic device ED04 through the server ED08. The electronic device ED01 may include a processor ED20, a memory ED30, an input device ED50, a sound output device ED55, a display device ED60, an audio module ED70, a sensor module ED76, and an interface ED77, a haptic module ED79, a camera module ED80, a power management module ED88, a battery ED89, a communication module ED90, a subscriber identification module ED96, and/or an antenna module ED97. Some of these components (e.g., the display device ED60) may be omitted from the electronic device ED01 or other components may be added to the electronic device ED01. Some of these components may be implemented as a single integrated circuit. For example, the sensor module ED76 (fingerprint sensor, iris sensor, illuminance sensor, etc.) may be embedded in the display device ED60 (display, etc.).

By executing software (e.g., a program ED40), the processor ED20 may control one or a plurality of other components (hardware, software components, etc.) of the electronic device ED01 connected to the processor ED20 and may perform various data processing or computation. As part of data processing or computation, the processor ED20 may load commands and/or data received from other components (a sensor module ED76, a communication module ED90, etc.), into a volatile memory ED32, and process the commands and/or data stored in the volatile memory ED32, and store resultant data in a nonvolatile memory ED34. The processor ED20 may include a main processor ED21 (a CPU, an AP, etc.) and an auxiliary processor ED23 (a graphics processing unit, an image signal processor, a sensor hub processor, communication processor, etc.) that may be operated independently of or together with the main processor ED21. The auxiliary processor ED23 may use less power than the main processor ED21 and may perform a specialized function.

The auxiliary processor ED23 may be configured to control functions and/or states related to some of the components of the electronic device ED01 (the display device ED60, the sensor module ED76, the communication module ED90, etc.) by replacing the main processor ED21 while the main processor ED21 is in an inactive state (sleep state), or together with the main processor ED21 when the main processor ED21 is in an active state (application execution state). The auxiliary processor ED23 (an image signal processor, a communication processor, etc.) may be implemented as a portion of other functionally related components (the camera module ED80, the communication module ED90, etc.).

The memory ED30 may store various data required by the components of the electronic device ED01 (the processor ED20, the sensor module ED76, etc.). The data may include, for example, input data and/or output data for software (e.g., the program ED40) and instructions related thereto. The memory ED30 may include a volatile memory ED32 and/or a nonvolatile memory ED34. The nonvolatile memory ED34 may include an internal memory ED36 fixedly mounted in the electronic device ED01 and a removable external memory ED38.

The program ED40 may be stored as software in the memory ED30, and may include an operating system ED42, middleware ED44, and/or an application ED46.

The input device ED50 may receive a command and/or data to be used in a component of the electronic device ED01 (e.g., the processor ED20) from the outside of the electronic device ED01 (a user, etc.). The input device ED50 may include a microphone, a mouse, a keyboard, and/or a digital pen (e.g., a stylus pen).

The sound output device ED55 may output a sound signal to the outside of the electronic device ED01. The sound output device ED55 may include a speaker and/or a receiver. The speaker may be used for general purposes, such as multimedia playback or recording playback, and the receiver may be used to receive incoming calls. The receiver may be integrated as a portion of the speaker or may be implemented as an independent separate device.

The display device ED60 may visually provide information to the outside of the electronic device ED01. The display device ED60 may include a display, a hologram device, or a projector and a control circuit for controlling these devices. The display device ED60 may include touch circuitry configured to sense a touch, and/or sensor circuitry configured to measure intensity of a force generated by the touch (e.g., a pressure sensor).

The audio module ED70 may convert sound into an electrical signal, or conversely, convert an electrical signal into a sound. The audio module ED70 may obtain a sound through the input device ED50 or output sound through a speaker and/or a headphone of other electronic devices (the electronic device ED02, etc.) directly or wirelessly connected to the sound output device ED55 and/or the electronic device ED01. The audio module ED70 may include a speaker classifying apparatus or a minutes taking apparatus according to an embodiment.

The sensor module ED76 may detect an operating state of the electronic device ED01 (power, temperature, etc.), or an external environmental state (user status, etc.), and generate an electrical signal and/or data corresponding to the sensed state value. The sensor module ED76 may include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface ED77 may support one or a plurality of designated protocols that may be used to directly or wirelessly connect the electronic device ED01 to another electronic device (e.g., the electronic device ED02). The interface ED77 may include a High Definition Multimedia Interface (HDMI), a Universal Serial Bus (USB) interface, a Secure Digital (SD) card interface, and/or an audio interface.

A connection terminal ED78 may include a connector through which the electronic device ED01 may be physically connected to another electronic device (e.g., the electronic device ED02). The connection terminal ED78 may include an HDMI connector, a USB connector, an SD card connector, and/or an audio connector (e.g., a headphone connector).

The haptic module ED79 may convert an electrical signal into a mechanical stimulus (vibration, movement, etc.) or an electrical stimulus that the user may perceive through tactile or kinesthetic sense. The haptic module ED79 may include a motor, a piezoelectric element, and/or an electrical stimulation device.

The camera module ED80 may capture a still image or record a moving picture. The camera module ED80 may include additional lens assembly image signal processors, and/or flash units. A lens assembly included in the camera module ED80 may collect light emitted from a subject, which is an object of image capturing.

The power management module ED88 may manage power supplied to the electronic device ED01. The power management module ED88 may be implemented as a portion of a power management integrated circuit (PMIC).

The battery ED89 may supply power to components of the electronic device ED01. The battery ED89 may include a non-rechargeable primary cell, a rechargeable secondary cell, and/or a fuel cell.

The communication module ED90 may support establishment of a direct (wired) communication channel and/or a wireless communication channel between the electronic device ED01 and other electronic devices (the electronic device ED02, the electronic device ED04, the server ED08, etc.) and communication through the established communication channel. The communication module ED90 may include one or a plurality of communication processors that operate independently of the processor ED20 (e.g., an AP) and support direct communication and/or wireless communication. The communication module ED90 may include a wireless communication module ED92 (a cellular communication module, a short-range wireless communication module, a global navigation satellite system (GNSS, etc.) communication module and/or a wired communication module ED94 (a local area network (LAN) communication module, a power line communication module, etc.). Among these communication modules, a corresponding communication module may communicate with other electronic devices through a first network ED98 (a short-range communication network such as Bluetooth, WiFi Direct, or Infrared Data Association (IrDA)) or a second network ED99 (a telecommunication network such as a cellular network, the Internet, or a computer network (LAN, WAN, etc.)). These various types of communication modules may be integrated into a single component (a single chip, etc.) or implemented as a plurality of components (multiple chips) that are separate from each other. The wireless communication module ED92 may confirm and authenticate the electronic device ED01 in a communication network, such as the first network ED98 and/or the second network ED99 by using subscriber information (e.g., International Mobile Subscriber Identifier (IMSI)) stored in the subscriber identification module ED96.

The antenna module ED97 may transmit or receive signals and/or power to or from the outside (e.g., other electronic devices). An antenna may include a radiator including a conductive pattern formed on a substrate (e.g., a printed circuit board (PCB)). The antenna module ED97 may include one or a plurality of antennas. When a plurality of antennas are included, an antenna suitable for a communication method used in a communication network, such as the first network ED98 and/or the second network ED99 may be selected by the communication module ED90 from among the plurality of antennas. A signal and/or power may be transmitted or received between the communication module ED90 and another electronic device through the selected antenna. In addition to the antenna, other components (e.g., a radio frequency integrated circuit (RFIC)) may be included as a portion of the antenna module ED97.

Some of the components may be connected to each other through a communication method between peripheral devices (e.g., a bus, general purpose input and output (GPIO), serial peripheral interface (SPI), mobile industry processor interface (MIPI)) and exchange signals (e.g., command, data, etc.).

A command or data may be transmitted or received between the electronic device ED01 and the external electronic device ED04 through the server ED08 connected to the second network ED99. The other electronic devices ED02 and ED04 may be of the same type as or a different type from that of the electronic device ED01. All or some of operations performed by the electronic device ED01 may be executed in one or a plurality of devices among the other electronic devices ED02, ED04, and ED08. For example, when the electronic device ED01 is to perform a function or service, instead of executing the function or service by itself, a request for performing a portion or all of the function or service may be made to one or a plurality of other electronic devices. One or a plurality of other electronic devices receiving the request may execute an additional function or service related to the request, and transmit a result of the execution to the electronic device ED01. To this end, cloud computing, distributed computing, and/or client-server computing technology may be used.

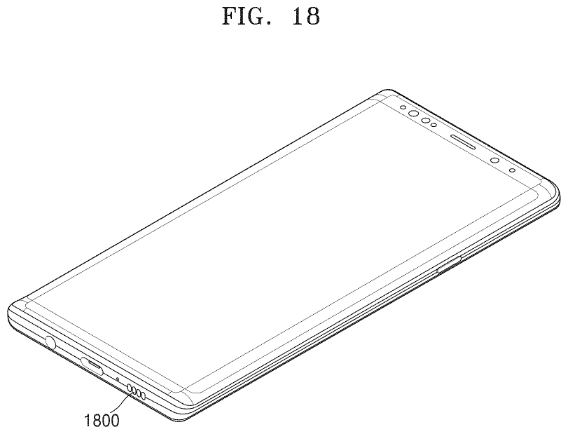

FIGS. 18 to 21 are example diagrams for explaining applications of various electronic devices to which the speaker classifying apparatus or the minutes taking apparatus according to another example embodiment may be applied.

As various electronic devices include the speaker classifying apparatus or the minutes taking apparatus according to an example embodiment, sound may be obtained by using a certain directional pattern with respect to a certain direction, a direction of transmitted sound may be detected, or sound around the electronic device may be obtained with spatial awareness. For example, when a first user and a second user have a conversation by using an electronic device as a medium, the electronic device may detect a direction in which each user is located, or sense only the voice of the first user by using a directional pattern oriented toward the first user, or sense only the voice of the second user by using a directional pattern oriented toward the second user, or simultaneously sense the voices of both users by distinguishing directions from which each user's voice is heard.

A speaker classifying apparatus or a minutes taking apparatus mounted on an electronic device has uniform sensitivity to various frequencies of sensed sound, and it is easy to manufacture the speaker classifying apparatus or the minutes taking apparatus having a compact size as there is no restriction on distances between respective acoustic sensors. Also, the degree of freedom of operation of the apparatuses is relatively high because various directional patterns may be selected and combined according to a location of a direction estimating apparatus or the conditions of the surroundings. In addition, only simple operations such as a sum or a difference are used to control the direction estimating apparatus, and thus computational resources may be used efficiently.

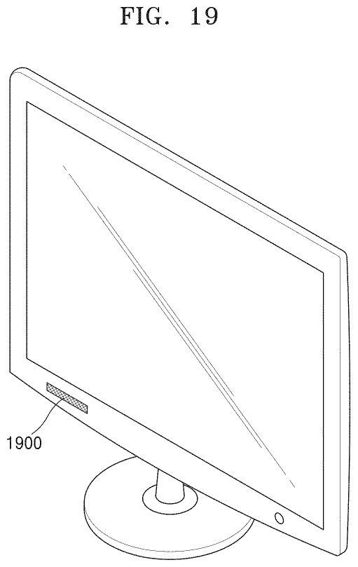

The speaker classifying apparatus or the minutes taking apparatus according to the example embodiments may be a microphone module 1800 provided in a mobile phone or smartphone illustrated in FIG. 18, or a microphone module 1900 provided in a TV illustrated in FIG. 19.

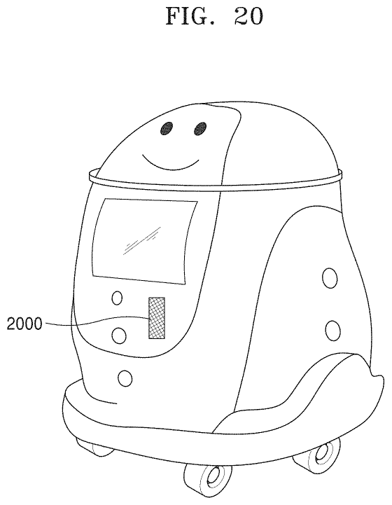

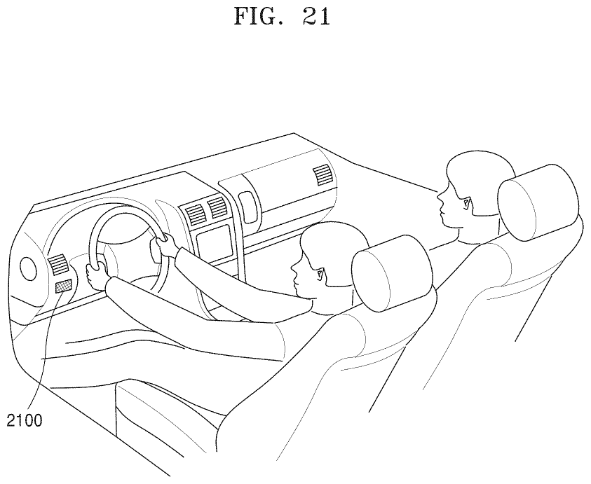

In addition, the speaker classifying apparatus or the minutes taking apparatus may be a microphone module 2000 provided in a robot illustrated in FIG. 20 or a microphone module 2100 provided over the overall length of a vehicle illustrated in FIG. 21.

Although the speaker classifying apparatus or minutes taking apparatus described above and an electronic device including the same have been described with reference to the example embodiment illustrated in the drawings, this is merely an example, and it will be understood by those of ordinary skill in the art that various modifications and equivalent other embodiments may be made. Therefore, the disclosed example embodiments should be considered in an illustrative rather than a restrictive sense. The scope of the present disclosure is defined not by the detailed description of the present disclosure but by the appended claims, and all differences within the scope will be construed as being included in the present disclosure.

The example embodiments described above can be written as computer programs and can be implemented in general-use digital computers that execute the programs using a computer-readable recording medium. Also, data structures used in the example embodiments described above may be written to the computer-readable recording medium using various means. Examples of the computer-readable recording medium include magnetic storage media (e.g., ROM, floppy disks, hard disks, etc.), optical recording media (e.g., CD-ROMs, or DVDs), and storage media such as carrier waves (e.g., transmission through the Internet).

It should be understood that example embodiments described herein should be considered in a descriptive sense only and not for purposes of limitation. Descriptions of features or aspects within each example embodiment should typically be considered as available for other similar features or aspects in other embodiments. While example embodiments have been described with reference to the figures, it will be understood by those of ordinary skill in the art that various changes in form and details may be made therein without departing from the spirit and scope as defined by the following claims and their equivalents.

What is claimed is:

1. A speaker classifying apparatus comprising:
an acoustic sensor; and
a processor configured to:
obtain a first direction of a sound source within an error range of −5 degrees to +5 degrees based on a first output signal output from the acoustic sensor;
recognize a speech of a first speaker in the first direction;
obtain a second direction of the sound source within the error range of −5 degrees to +5 degrees based on a second output signal output after the first output signal; and
recognize a speech of a second speaker in the second direction based on the second direction being different from the first direction.

2. The speaker classifying apparatus of claim 1, wherein the processor is further configured to recognize a change of a speaker based on the first direction or the second direction being maintained or changed with respect to continuous output signals.

3. The speaker classifying apparatus of claim 1, wherein the processor is further configured to register the first speaker and a recognized voice of the first speaker based on the speech of the first speaker being recognized.

4. The speaker classifying apparatus of claim 3, wherein the processor is further configured to compare a similarity between a voice corresponding to the second output signal with a registered voice of the first speaker.

5. The speaker classifying apparatus of claim 4, wherein the processor is further configured to recognize a speech of a second speaker in the second direction based on the second direction being different from the first direction and the similarity being less than a first threshold.

6. The speaker classifying apparatus of claim 4, wherein the processor is further configured to recognize the speech of the first speaker based on the similarity being greater than a second threshold value.

7. The speaker classifying apparatus of claim 1, wherein the processor is further configured to recognize voices respectively corresponding to the speech of the first speaker and the speech of the second speaker, and classify the recognized voices based on speakers.

8. The speaker classifying apparatus of claim 1, wherein the acoustic sensor comprises at least one directional acoustic sensor.

9. The speaker classifying apparatus of claim 1, wherein the acoustic sensor comprises a non-directional acoustic sensor and a plurality of directional acoustic sensors.

10. The speaker classifying apparatus of claim 9, wherein the non-directional acoustic sensor is provided at a center of the speaker classifying apparatus, and
wherein the plurality of directional acoustic sensors are provided adjacent to the non-directional acoustic sensor.

11. The speaker classifying apparatus of claim 10, wherein the first direction and the second direction are estimated different from each other based on a number and arrangement of the plurality of directional sensors.

12. The speaker classifying apparatus of claim 9, wherein a directional shape of output signals of the plurality of directional acoustic sensors comprises a figure-of −8 shape regardless of a frequency of a sound source.

13. A minutes taking apparatus using an acoustic sensor, the minutes taking apparatus comprising:
an acoustic sensor; and
a processor configured to:
obtain a first direction of a sound source within an error range of −5 degrees to +5 degrees based on a first output signal output from the acoustic sensor and recognize a speech of a first speaker in the first direction;
obtain a second direction of the sound source within the error range of −5 degrees to +5 degrees based on a second output signal output after the first output signal, and when the second direction is different from the first direction, recognize a speech of a second speaker in the second direction; and
recognize voices respectively corresponding to the speech of the first speaker and the speech of the second speaker and take minutes by converting the recognized voices into text.

14. The minutes taking apparatus of claim 13, wherein the processor is further configured to recognize a change of a speaker based on the first direction or the second direction being maintained or changed with respect to continuous output signals.

15. The minutes taking apparatus of claim 14, wherein the processor is further configured to determine a similarity between a recognized voice of the first speaker and a voice of the second output signal.

16. The minutes taking apparatus of claim 15, wherein the processor is further configured to recognize the second output signal as the speech of the first speaker when the similarity is greater than a threshold value, and recognize the second output signal as the speech of the second speaker when the similarity is less than the threshold value.

17. A speaker classifying method using an acoustic sensor, the speaker classifying method comprising:
obtaining a first direction of a sound source within an error range from −5 degrees to +5 degrees based on a first output signal output from the acoustic sensor;
recognizing a speech of a first speaker in the first direction;
obtaining a second direction of the sound source within the error range from −5 degrees to +5 degrees based on a second output signal output after the first output signal; and
recognizing, based on the second direction being different from the first direction, a speech of a second speaker in the second direction.

18. A minutes taking method using an acoustic sensor, the minutes taking method comprising:
obtaining a first direction of a sound source within an error range from −5 degrees to +5 degrees based on a first output signal output from the acoustic sensor;
recognizing a speech of a first speaker in the first direction;
obtaining a second direction of the sound source within the error range from −5 degrees to +5 degrees based on a second output signal output after the first output signal;
recognizing a speech of a second speaker in the second direction based on the second direction being different from the first direction;
recognizing voices respectively corresponding to the speech of the first speaker and the speech of the second speaker; and
taking minutes by converting the recognized voices into text.

19. An electronic device comprising the speaker classifying apparatus according to claim 1.

20. An electronic device comprising the minutes taking apparatus according to claim 13.
